(19) United States
(12) Patent Application Publication
(10) Pub. No.: US 2025/0201223 A1
(43) Pub. Date: Jun. 19, 2025

(54) GUITAR PICKUP

(71) Applicant: Job WHITE, Altershot (GB)

(72) Inventor: Job WHITE, Altershot (GB)

(21) Appl. No.: 18/538,227

(22) Filed: Dec. 13, 2023

(51) Int. Cl. G10H 3/18

(52) U.S. Cl. CPC G10H 3/181

(57) ABSTRACT

The present invention relates to a stringed instrument pickup comprising a first bobbin plate and a second bobbin plate, a plurality of magnetic pole-pieces extending between the bobbin plates and conductive wire coiled around the pole-pieces. At least one of the bobbin plates is made of an electrically conductive material for shielding the conductive wire from ambient electromagnetic interference and comprises a plurality of electrically resistive portions for resisting eddy currents in the plate.

### FIELD OF THE INVENTION

The present invention relates to a pickup for a stringed instrument. The invention finds particular but not exclusive utility in a single coil pickup.

### BACKGROUND

Electric guitars originate from the early 1900's and started to become very popular in the 1940-50's. Guitars today still adopt the same single coil guitar pickups, as was the case 80 years ago. In the 1950's the ‘Humbucker’ pickup was famously introduced which has the effect of reducing the 50/60 Hz (60 Hz in the US and 50 Hz in other regions) mains hum that would naturally be induced. The Humbucker comprises two arrays of magnetic pole-pieces, one array having reversed magnetic polarity to the other array with windings in a reverse directions on the two arrays. A single coil pickup has only a single array of pole-pieces having a single magnetic polarity and a single winding direction. However, humbucker pickups produce a different tonality, and a guitar player may desire the tonality of a single coil pickup.

With the passage of the time, levels of ambient electromagnetic noise/interference has increased in our atmosphere, with the use of computers, mobile phones, Wi-Fi, LED lights etc. The windings of a pickup are configured specifically to pick up a variation in the magnetic flux generated by guitar string vibration through a pole-piece but also pick up undesirable stray electromagnetic fields.

The need for a ‘noise-free’ (not hum free) single coil pickup is at its greatest. Known guitar pickups, particularly single coil pickups, are not ideally suited for a noise free delivery without the generation of unwanted hum. It is an aim of the invention to provide an improved solution.

### SUMMARY OF THE INVENTION

The present invention provides a string instrument pickup comprising a first bobbin plate and a second bobbin plate, a plurality of magnetic pole-pieces extending between the bobbin plates and conductive wire coiled around the pole-pieces, wherein at least one of the bobbin plates is made of an electrically conductive material for shielding the wire from ambient electromagnetic interference and comprises a plurality of electrically resistive portions for resisting eddy currents in the plate.

The electrically resistive portions may comprise interruptions formed in the electrically conductive material that extend into the plate for resisting the flow of current across the interruption.

In use the pole-pieces are arranged in a transverse dimension and are in alignment with respective stringed instrument strings, and the interruptions extend in a dimension generally perpendicular to the transverse dimension. The interruptions may be non-linear.

The interruptions may extend substantially fully across the plate to form plate segments between the interruptions, the plate segments being aligned with respective pole-pieces.

The interruptions may comprise cuts formed though the plate from one side to the other. Preferably the cuts pass through the entire thickness of the plate but do not pass along the full width of the plate. In this way the plate remains as a single part with partial cuts and structural integrity is further maintained.

To prevent spreading at the cuts, the cuts may be bonded or adhered together. For example the surfaces of the plate may be coated with a layer of material such as f epoxy resin.

In a preferred embodiment the plate has cuts that form interlocking parts, similar to puzzle pieces, so that lateral movement is prevented. It is appreciated that the interlocking cuts may still be bonded or adhered together for additional strength. For example the plates may be formed from separate interlocking segments that are joined by adhesive or bonding. It is appreciated that the segments will be physically connected by at least one connection between adjacent segments to ensure that each segment can be earthed by a central connection.

Preferably at least one of the bobbin plates that is electrically conductive may be connected to an earth (grounded). For example a connector may be provided for connecting a bobbin plate to and earth. As an electrically conductive bobbin plate is electrically connected to the pole pieces the pole pieces can be simultaneously grounded.

In a preferred embodiment both the first bobbin plate and the second bobbin plate are made of an electrically conductive material for shielding the conductive coil of wire from ambient electromagnetic interference, as described in the preceding paragraphs of the summary of the invention.

When both plates are electrically conductive either may have a connector for connecting the plate to an earth because as the plates are both conductive and the pole pieces are electrically connected, only one plate needs a connector, for example the bottom plate in use to simultaneously earth both plates and the pole pieces.

Each bobbin plate may comprise a plurality of electrically resistive portions for resisting eddy currents in the plate(s). The electrically resistive portions may take any suitable form for resisting the flow of eddy current from one part of a plate to another part of the plate, or from one plate to the other plate through the pole-pieces.

The conductive coiled wire, or coil, is wound around the pole-pieces. In a preferred embodiment the coil is formed from 42 AWG wire with approximately 5000 to 8000 turns.

An electrically conductive film may be deposited around and electrically insulated from the coiled wire, the film having a connector for connecting the film to earth. For example, the coiled wire may be covered in a thin film of copper which is connected to an earth.

The pickup or parts thereof may be dipped in wax to provide a resistance to vibration.

A hook-up wire for connecting to the ends of the conductive wire coiled around the pole-pieces may be provided for connecting the ends to a stringed instrument such as a guitar/amplifier and earth respectively. The hook-up wire comprises shielding for shielding the hook-up wire from electromagnetic interference.

The shielding of the hook-up wire may comprise an electrically conductive material insulated from the hook-up wire and having a connection for connecting the shielding to earth. Advantageously by having the wire shielding connected to earth this serves as a barrier from noise and interference, protecting the signal wires within.

The electrically resistive portions (shielding) comprises an electrically insulating material, such as a dielectric.

A plurality of conductive wires may be coiled around respective pole-pieces and connected to a stringed instrument/stringed instrument amplifier.

The winding may comprise a single coil, or alternatively the pickup may have a humbucker arrangement (two single coils).

The invention also covers a stringed instrument comprising at least one stringed instrument pickup described in the preceding paragraphs of the summary of the invention.

In use when a stringed instrument such as a guitar is played containing a known single coil pickup, the string/s are plucked to make the strings oscillate. This oscillation causes a disturbance in the magnetic field that is produced by the pickup and a small voltage is therefore induced into the coil. The coil will also induce any other airborne electrical noise/interference. The sound made by plucking the string of the guitar is mixed with unwanted noise/interference and this signal is then amplified by the guitar amplifier. The combination of the intended sound and other noise and interference generates a noisy signal.

When a stringed instrument is played using a pickup of the present invention the induced voltage to the coil via the strings oscillation when played occurs in the same way, however as the coil is shielded from any airborne noise/interference and as the cuts to the bobbin plates help reduce eddy currents, noise and interference is reduced so that a purer signal/sound with a unique tonal profile is played.

A preferred embodiment of the invention will now be described by way of example only and with reference to the Figures in which:

### BRIEF DESCRIPTION OF FIGURES

FIG. 1 shows an exploded view of the proposed single coil guitar pickup assembly; and

FIG. 2 shows an exploded view of a prior art device which is a typical single coil guitar pickup assembly.

### DETAILED DESCRIPTION OF FIGURES

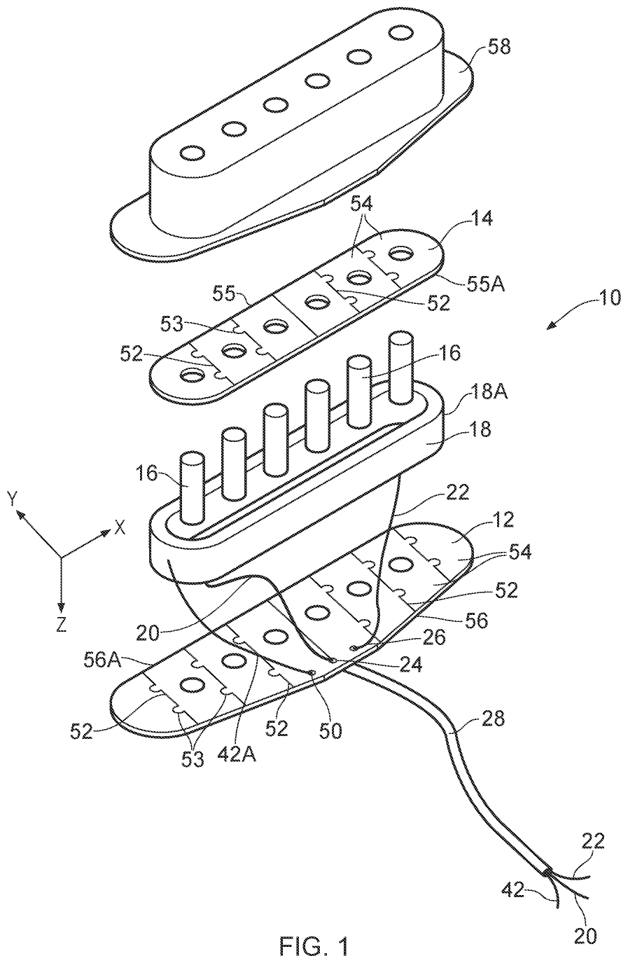

Referring to FIG. 1, there is shown a preferred example of the invention which is a single coil guitar pickup 10 comprising a first bobbin plate 12 and a second bobbin plate 14, a plurality of magnetic pole-pieces 16 extending between the bobbin plates and conductive wire 18 coiled around the pole-pieces. The conductive wire coil 18 is covered by a copper foil 18A that is applied around the coil 18 and that also connects to ground via the wire 42. The copper foil helps to protect and shield the coil from electromagnetic interference. The copper foil 18A is connected to a ground wire 42A that connects to ground by the wire 42.

The pole-pieces may be made of a ferro-magnetic material such as iron. The pole-pieces correspond to guitar strings in order to pick up vibration of each string individually. As typically there are six strings on such a musical instrument there are six pole-pieces, but other types of instruments may have a different number of strings and pole-pieces. When a guitar string is plucked by a player it vibrates and this vibration changes the magnetic flux applied by the corresponding pole-piece to the conductive wire coil and hence induces an electrical current in the wire. The current is subsequently amplified and played through a speaker to produce an audible sound correlating with the vibration of the guitar string.

The conductive wire is typically made of a metal such as copper having high electrical conductivity. The gauge of the wire is between about 50 and 10 American Wire Gauge (AWG), about 0.025 and 2.5 mm diameter. The wire is coated with an electrical insulator material and may be enamelled or plasticised. There may be between about 5000 and 15000 loops of wire around the pole-pieces.

The end portions 20, 22 of the wire are threaded through holes 24, 26 in one of the bobbin plates and extend through an electrically insulating sheath 28 of a hook-up wire or output cable so that the ends of the wire can be connected with an amplifier. The end portion 20 is earthed and the end portion 22 is ‘hot’ and carries the feedback current for amplification.

Referring again to FIG. 1, at least one and preferably both of the bobbin plates 12, 14 are made of an electrically conductive material for shielding the wire from ambient electromagnetic interference. Such materials include without limitation steel, such as stainless steel, aluminium, and carbon fibre. Known guitar pickups comprise bobbin plates of material having low or very low electrical conductivity, such as ceramic, plastics or another dielectric material. The or each bobbin plate comprises a connector for connecting the plate to earth. As shown the connector is a hole 50 in the bobbin plate 12 connected with a wire 42A that is grounded through wire 42. In FIG. 1 bobbin plate 12 is connected to wire 42 and bobbin plate 14 is connected to bobbin plate 14 for grounding by pole-pieces 16 that are in electrical connection with both bobbin plates.

Alternatively, one bobbin plate 14 (or bobbin plate 12) may not be conductive or not grounded or made of a dielectric material, and one bobbin plate may be conductive and grounded.

A disadvantage to the use of a bobbin plate(s) made of a conductive material is that eddy currents are generated in the plate(s) to oppose the induced current in the wire(s) 18 when the magnetic flux of the pole-pieces 16 increases. Eddy currents vary depending on the conductive material used for the bobbin plates and aluminium is especially troublesome in this regard. These eddy currents reduce the induced current in the copper coils 18 and therefore cause a loss of power and tone generated by playing a guitar.

An advantage to conductive bobbin plates over and above the shielding they provide is, as indicated above, that the pole-pieces are electrically connected with the bobbin plates and are therefore grounded (earthed). Earthed pole-pieces are resistant to ambient electromagnetic interference.

The bobbin plate(s) comprise a plurality of electrically resistive portions 52 for resisting eddy currents in the plate(s). The electrically resistive portions 52 may take any suitable form for resisting the flow of eddy current from one part of a plate to another part of the plate, or from one plate to the other plate through the pole-pieces.

As shown in FIG. 1, the electrically resistive portions comprise interruptions 52 formed in the electrically conductive material extending into the plate for resisting the flow of current across the interruption 52. In use the pole-pieces 16 are arranged in a transverse dimension X and are in alignment with respective guitar strings, and the interruptions 52 extend in a dimension Y generally perpendicular to the transverse dimension. These interruptions 52 physically separate part of the plate on either side of the interruptions so that current flow is resisted or prevented.

In the pictured embodiment the interruptions 52 in the upper bobbin plate 14 have a continuous edge 55 on a first side and the interruptions (cuts) 52 pass completely through the opposed second edge 55A.

The interruptions 52 in the lower bobbin plate 12 have a continuous edge 56 that is opposite to the continuous edge 55 of the upper bobbin plate 14. The interruptions (cuts) 52 pass completely through the opposed second edge 56A. In this way the cuts 52 and continuous edges 55, 56 are on opposite edges on each plate 12, 14 when mounted on the pole-pieces 16 which provides greater structural integrity.

In this example the interruptions are non-linear cuts through the bobbin plates 12, 14 and each segment 54 of the plates comprises one or more semi-circular tabs 53 (two such tabs as shown). The purpose of these semi-circular tabs 53 is to interlock the segments of the plates with the adjacent piece to form the plate. The tabs 53 have a waist so that tab interlocks with an adjacent segment to provide structural integrity in a similar way as to puzzle pieces thereby preventing lateral spread.

The interruptions 52 may be shaped in any way to resist current flow and may be curvilinear, zigzagged, tortuous etc.

The interruptions 52 extend partially across the plate in the Y dimension to define plate segments 54 between the interruptions 52, the plate segments 54 being aligned with respective pole-pieces 16. Each plate segment 54 aligned with a pole-piece 16 comprises a hole or other formation (not shown) for receiving and positioning a pole-piece 16, and for electrically connecting with a pole-piece.

In the pictured example of the interruptions they comprise cuts formed though part of the width of the plate from one side to the other in the Z dimension. Each plate has a continuous edge 55, 56 through which the cuts 52 do not extend so that all the segments 54 are physically connected to enable all sections to be earthed by the wire 42.

In other examples eddy current may be substantially reduced by forming a cut almost through the plate but not entirely.

The pictured bobbin plates 12, 14 have a central connection to an earth through the wire 42. It is appreciated that the connection does not need to be central as all segments are connected and the wire connection that includes an earth, may be non-central, for example being located at ends of the plates, or off centre.

The segments 54 are not fully electrically insulated from one another due to the connecting edges 55, 56, so that all segments 54 are grounded through the central connection 42. The formation of the bobbin plates 12, 14 from segments 54 helps to resist the flow of eddy currents in order to help restore lost power and improve tone of the guitar pickup.

Whilst a physical gap containing air in the interruptions provides electrical insulation, in some examples, insulation is further improved if the electrically resistive portions comprise an electrically insulating material, such as a dielectric including plastics, glass, ceramics etc. In other examples the bobbin plate(s) may be coated with a dielectric that also penetrates the interruptions.

A cover 58 covers the functional components of the pickup. Usually the cover is made of plastics or ceramics or otherwise electrically insulating but magnetically transparent. The cover protects the components from damage. Holes in cover are aligned with pole-pieces so that pole-pieces can protrude through cover if that is required.

The pickup is maybe dipped in wax to provide a resistance to vibration.

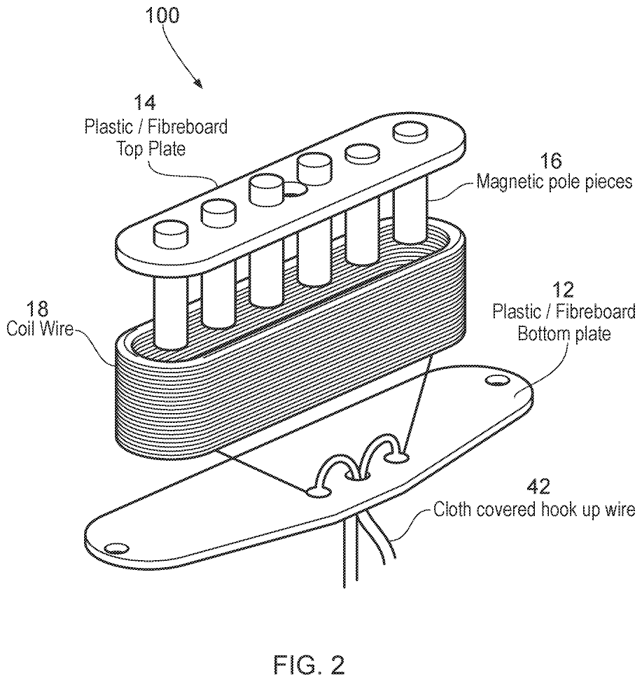

FIG. 2 shows a known single coil guitar pickup 100. The prior art device 100 does not have conductive bobbin plates and the plates do not have interruptions across or through the plates.

Humbucker guitar pickups are referenced in the discussion of the prior art and that they may not be desirable if a single coil pickup is required to produce a preferred tone or sound. Nevertheless, the present arrangement as described with reference to FIG. 1 may be adopted in a Humbucker so that all four bobbin plates correspond to those described herein.

An electric guitar typically comprises one or more pickups. Most often there are neck and bridge pickups, but there may be third pickup intermediate the bridge and neck pickups. The position of the pickups affects the induced current in the windings and the amplified sound reproduced.

Although the device is referred to as a guitar pickup, it is appreciated that the pickup may be used on other stringed instruments.

The invention has been described by way of examples only and it will be appreciated that variation may be made to the above-mentioned embodiments without departing from the scope of invention as defined by the claims, in particular but not solely combination of features of described embodiments.

1. A stringed instrument pickup comprising a first bobbin plate and a second bobbin plate, a plurality of magnetic pole-pieces extending between the bobbin plates and conductive wire coiled around the pole-pieces, wherein at least one of the bobbin plates is made of an electrically conductive material for shielding the conductive wire from ambient electromagnetic interference and comprises a plurality of electrically resistive portions for resisting eddy currents in the plate.

2. A stringed instrument pickup as claimed in claim 1, wherein the electrically resistive portions comprise interruptions formed in the electrically conductive material extending into the plate for resisting the flow of current across the interruption.

3. A stringed instrument pickup as claimed in claim 2, wherein in use the pole-pieces are arranged in a transverse dimension and are in alignment with respective stringed instrument strings, and the interruptions extend in a dimension generally perpendicular to the transverse dimension.

4. A stringed instrument pickup as claimed in claim 3, wherein the interruptions are non-linear.

5. A stringed instrument pickup as claimed in claim 2, wherein the interruptions extend substantially fully across the plate to form plate segments between the interruptions, the plate segments being aligned with respective pole-pieces.

6. A stringed instrument pickup as claimed in claim 2, wherein the interruptions comprise cuts formed though the width of at least part of the plate.

7. A stringed instrument pickup according to claim 6 wherein each plate has one continuous edge through which there are no cuts.

8. A stringed instrument pickup as claimed in claim 6 wherein the cuts are made to form interlocking pieces.

9. A stringed instrument pickup as claimed in claim 1, wherein at least one of the plates has a connector for connecting the plate to earth.

10. A stringed instrument pickup as claimed in a claim 1, wherein both the first bobbin plate and the second bobbin plate are made of an electrically conductive material for shielding the conductive wire from ambient electromagnetic interference.

11. A stringed instrument pickup as claimed in claim 10, wherein each bobbin plate comprises a plurality of electrically resistive portions for resisting eddy currents in the plates.

12. A stringed instrument pickup as claimed in claim 1, comprising an electrically conductive film deposited around and electrically insulated from the conductive wire, the film having a connector for connecting the film to earth.

13. A stringed instrument pickup as claimed in claim 1, wherein the pickup is dipped in wax to provide a resistance to vibration.

14. A stringed instrument pickup as claimed in claim 1, comprising a hook-up wire for connecting to the ends of the conductive wire coiled around the pole-pieces for connecting the ends to a stringed instrument/stringed instrument amplifier and earth respectively, wherein the hook-up wire comprises shielding for shielding the hook-up wire from electromagnetic interference.

15. A stringed instrument pickup as claimed in claim 14, wherein the shielding of the hook-up wire comprises an electrically conductive material insulated from the hook-up wire and having a connection for connecting the shielding to earth.

16. A stringed instrument pickup as claimed in claim 1, wherein a plurality of conductive wires is coiled around respective pole-pieces and connected to a stringed instrument/stringed instrument amplifier.

17. A plate formed from a plurality of interlocking segments for use with the stringed instrument pickup according to claim 1.

18. A stringed instrument comprising at least one stringed instrument pickup as claimed in claim 1.

19. A stringed instrument pickup as claimed in claim 7 wherein the cuts are made to form interlocking pieces.
